(19) United States
(12) Patent Application Publication
(10) Pub. No.: US 2004/0199642 A1
(43) Pub. Date: Oct. 7, 2004

(54) Service architecture for session initiation protocol stack

(76) Inventors: Eric Tremblay, Orford (CA); Alexandre Charest, Sherbrooke (CA)

Correspondence Address: Mark D Lorusso, Lorusso Loud & Kelly, 440 Commercial Street, Boston, MA, 02109, US

(21) Appl. No.: 10/483,573

(22) PCT Filed: Jul. 12, 2002
(86) PCT No.: PCT/CA02/01069

(30) Foreign Application Priority Data
Jul. 12, 2001 (CA) 2352967

(51) Int. Cl. G06F 15/16

(52) U.S. Cl. 709/227

(57) ABSTRACT

This invention concerns architecture for a SIP stack that enables the addition or removal of new services without this having any impact on the other part of the stack. The user agent class contains sessions, the session class contain transactions and service implementations, while the transaction class simply contains service implementations. The user-agent class is programmed to retrieve session service implementations from the application and to attach them to session instances. The session class is programmed to receive transaction service implementations from the application, via the user agent class and to attach them to transaction instances. The proposed architecture allows an application to simultaneously support more than one version of a specific service. Added benefits also include making the customization process of these services quite easy.

### FIELD OF THE INVENTION

The present invention relates to Internet Protocol (IP) applications. More specifically, the present invention is concerned with such service implementation under the Session Initiation Protocol (SIP).

### BACKGROUND OF THE INVENTION

Session Initiation Protocol (SIP) is an Internet Protocol (IP) that has been initially introduced in Request for Comment (RFC) 2543 under the supervision of the Internet Engineering Task Force (IETF). Since its introduction, SIP continues to progress and change frequently and a still increasing number of extensions are available to augment the functionality of the initial SIP specification.

The SIP protocol is implemented via a stack, which, in the case of the SIP stack is an application level stack. It is interposed between the user (application) and other protocol layers underneath, which leads, through the Internet, to another SIP stack. Indeed, SIP, among other things, is a protocol for establishing a communication between two end-users.

An example of SIP stack architecture 10 according to the prior art is illustrated in FIG. 1 of the appended drawings. It is to be noted that all the examples illustrated hereinbelow concern Internet telephony.

The SIP stack 10 includes an end-point controller in the form of a user agent class 12. As it is conventionally known in the art, the user agent offers high-level interface and keeps current user information, local contact and a list of active sessions. Indeed, the user agent 12 aggregates zero or more session 14, which in turn aggregates zero or more transaction 16.

The functions of the session class 14 includes mid-level interface, keeping Call-ID, remote user info, and local and remote message sequence numbers (CSeq), comparing incoming packets to detect to which session they are associated with, creating basic SIP packets, holding session state, and keeping a list of active transactions 16.

The transaction class 16 responsibilities include low-level interface, holding transaction state, and retransmitting packets.

Each of the user agent 12, session 14 and transaction classes 16 includes services in the form of programmed functions 18. These functions 18 offer to the application 20 an extra layer of functionality, thus simplifying what the application 20 has to do in order to use the SIP protocol.

In FIG. 2, there is illustrated an example of operation of the stack 10. This particular example concerns the establishment of a session.

More specifically, in step 22, the application 20 instructs a user agent instance 12 to create a session instance 14 and in step 24, the user agent instance 12 dynamically creates a session instance 14.

In step 26, the application 20 gives an instruction to a user-agent instance 12 to initiate a call. The user agent instance 12 then locates the corresponding session instance 14 and forwards the call initiation instruction from the application 20 (step 28). The session then creates a basic SIP packet (step 30) and a transaction instance 16 (step 32). In step 34, the instruction is given by the session instance 14 to send the created packet. The transaction instance 16, which includes part of the “MakeCall” service functionality, sends the packet (step 36).

As illustrated in FIGS. 1 and 2, the session class 14 comes with the services that have been pre-programmed into the stack before it can be instantiated. Indeed, with such architecture, the service code is distributed throughout the user agent 12, the session 14 and transaction classes 16. The intelligence (various states management) is pre-programmed in the session 14 and in the transaction classes 16. The Application Programming Interface (API) has to be duplicated at each level. A negative consequence of this is that the integration of a new SIP feature requires modifying the User-Agent, session and transaction classes.

Since all the intelligence is located in the session and transaction classes, another drawback is that integrating a new SIP feature in those might easily affect the already existing services.

A further drawback of the SIP stack architecture according to the prior-art is that it cannot allow supporting different versions of a service without memory overhead at run-time.

Furthermore, as the user agent, session and transaction classes grow in functionality; they will also grow in complexity because of their inter-relation and of the centralized nature of the code. Also, since the specifics regarding a certain service are not isolated within a single class, it brings the possibility of an unwanted modification due to a shared code change.

Since every extension are not necessarily relevant to every type of SIP application and that a SIP application often needs to be as lightweight as possible, an easy way to add or remove features to the stack is thus desirable. Moreover, if a client wants to add a new service to a delivered application, he should be able to add it to the stack as fast as possible, without modifying the already existing services.

Presently, some applications require modifications to the features or services it support in order to work around a problem the other endpoint it is communicating with has. Some applications also support, for example, a version of a service while another application support another version of the same service. It is thus desirable for some vendors to be able to support both versions for different sessions, and to be easily able to create patched services that would allow interworking with a defective endpoint.

### SUMMARY OF THE INVENTION

SIP stack architecture according to the present invention allows preventing the previously described problems of architectures from the prior art.

More specifically, in accordance with the present invention, there is provided a Session Initiation Protocol (SIP) stack for a SIP application programmed to use at least one service, the stack comprising:

an end-point controller linked to the SIP application for creating at least one SIP session so that each of the at least one session is linked to the end-point controller, and for holding and managing the at least one SIP session for the SIP application; the end-point controller being programmed to receive at least one session service implementation from the application and to attach the at least one session service implementation to one of the at least one SIP session;

the at least one session being programmed for creating at least one transaction so as to be linked thereto, and for holding and managing the at least one transaction and the at least one session service implementation for the application; the at least one session being programmed to retrieve at least one transaction service implementation from the at least one session services and to attach the at least one transaction service implementation to the at least one transaction; and

the at least one transaction being programmed for holding and managing the at least one transaction service.

According to a second aspect of the present invention, there is provided a method of use of at least one service in a Session Initiation Protocol (SIP) application, the method comprising:

i) upon receiving appropriate command from the application, an end-point controller creating at least one session so that each of the at least one session is linked to the end-point controller;

ii) for each current service from the at least one service:

a) the application linking to the current service; and

b) upon receiving appropriate command from the application, the end-point controller receiving a session service implementation corresponding to the current service from the application and attaching the session service implementation to a selected one of the at least one session;

iii) upon receiving appropriate command from the application via the end-point controller, the selected one of the at least one session creating a transaction so that the transaction is linked to the selected one of the at least one session;

iv) upon receiving appropriate command from the application via the end-point controller, the selected one of the at least one session retrieving at least one transaction service implementation from the at least one session service and attaching each the at least one transaction service implementation to the transaction; and

v) upon receiving appropriate command from the application, one of the at least one the transaction service implementation using the transaction so as to create and/or modify a packet.

According to a third aspect of the present invention, there is provided a method for adding a service from a Session Initiation Protocol (SIP) application to a SIP stack comprising an end-point controller linked to the application, at least one session linked to the end-point controller, and at least one transaction linked to a selected one of the at least one session, the method comprising:

the application linking to the service;

upon receiving appropriate command from the application, the end-point controller receiving a session service implementation corresponding to the service from the application and attaching the session service implementation to the selected one of the at least one session; and

upon receiving appropriate command from the application via the end-point controller, the selected one of the at least one session retrieving a transaction service implementation from the session service implementation and attaching the transaction service implementation to the transaction.

SIP stack architecture according to the present invention allows supporting more than one version of a service (or feature), as long as they are not active at the same time on the same session.

It also allows an application using the user agent API to easily modify or replace an existing service implementation.

It is to be noted that for concision purposes the same numeral references will be used herein for the various classes and instances for these classes. However, the above terminology will be used to differentiate these two different entities. Whenever, neither the term class nor instance is used, the corresponding expression should be construed as referring to an instance.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1, which is labelled “prior art”, is a Unified Modeling Language (UML) class diagram of a SIP stack architecture according to a the prior art;

FIG. 2, which is labelled “prior art”, is a sequence diagram illustrating an example of operation of the SIP stack of FIG. 1;

FIG. 3 is a UML class diagram of SIP stack architecture according to an embodiment of the present invention;

FIG. 4A is a sequence diagram illustrating the creation of a SIP session class instance from the SIP stack of FIG. 3, and the addition of services to the created SIP session class instance, according to an embodiment of the present invention; and

FIGS. 4B-4D represent a sequence diagram illustrating a method of use of a service in a SIP application, according to the present invention.

### DESCRIPTION OF THE PREFERRED EMBODIMENT

The architecture according to the present invention is said to be based on services, since all the features of the stack can be developed as a class that derives (or inherits) from a basic “service” C++ interface class. The user agent or another end-point controller, the session and the transaction classes know and use the interface to this abstract service class, while in fact they are using a complete service implementation provided by the application.

As it will become more apparent upon reading the following description, the present invention advantageously uses the polymorphism feature of the C++ programming language. Of course, any other programming language presenting the polymorphism feature, such as Java can alternatively be used to implement a SIP stack according to the present invention. A non object-oriented programming language may be used by having the stack implement the basic mechanisms offered by the object-oriented polymorphism.

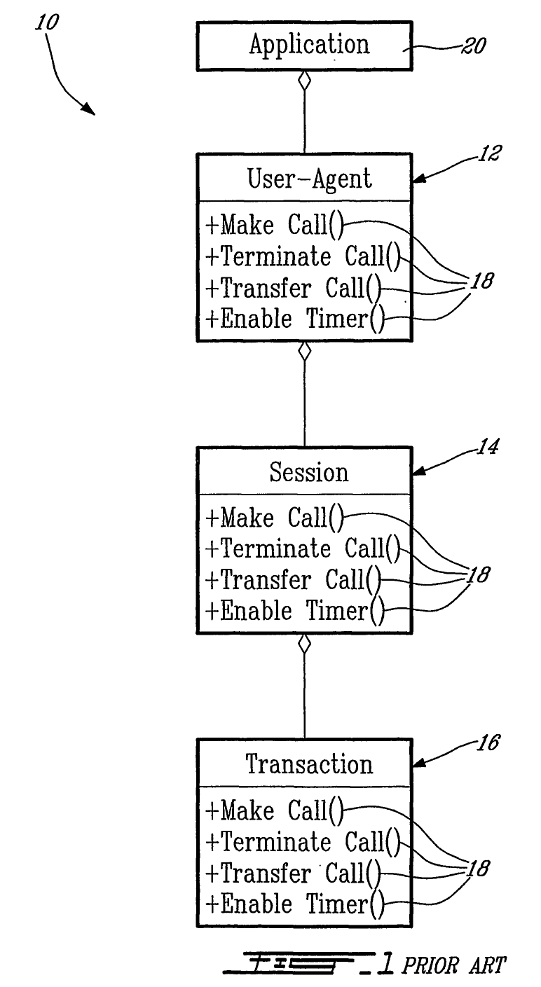

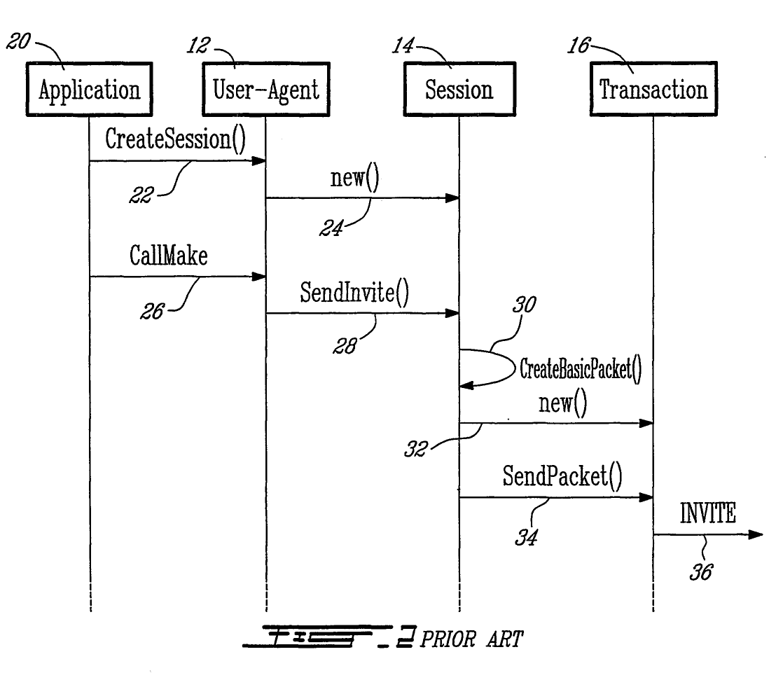

The proposed architecture allows plugging-in and out the intelligence at the session and transaction level. The architecture is similar as the one depicted in FIG. 1, but the user agent, Session and Transaction classes hold almost no intelligence. Instead, they act as containers. In a nutshell, the user agent aggregates sessions, the session aggregates transactions and service implementations, while the transaction simply aggregates service implementations.

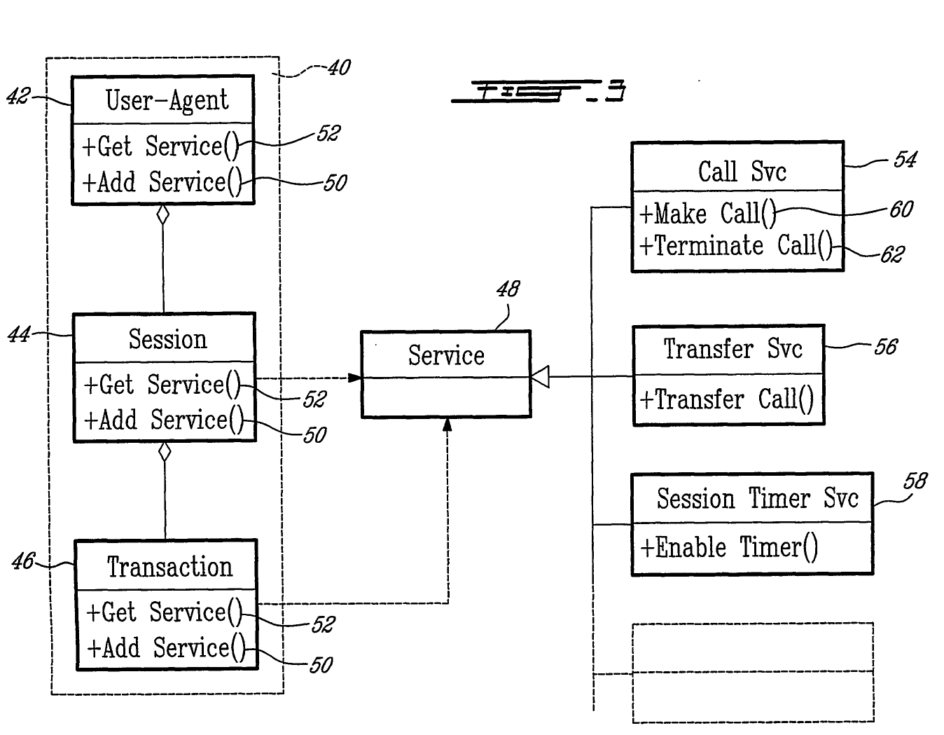

Turning now to FIG. 3, service architecture for a SIP stack according to an embodiment of the present invention will be described in more detail.

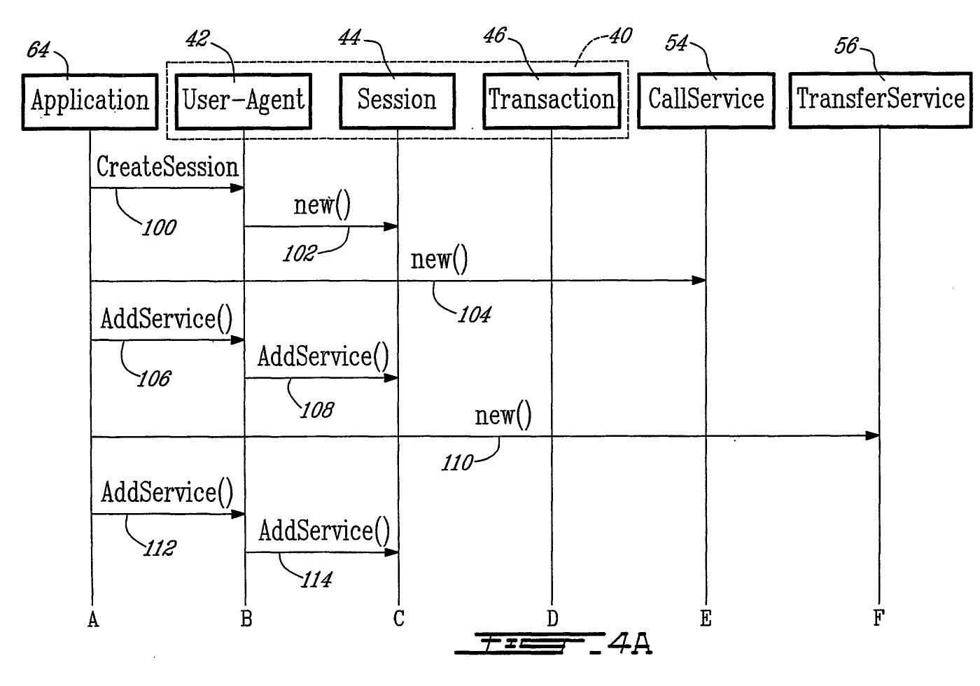

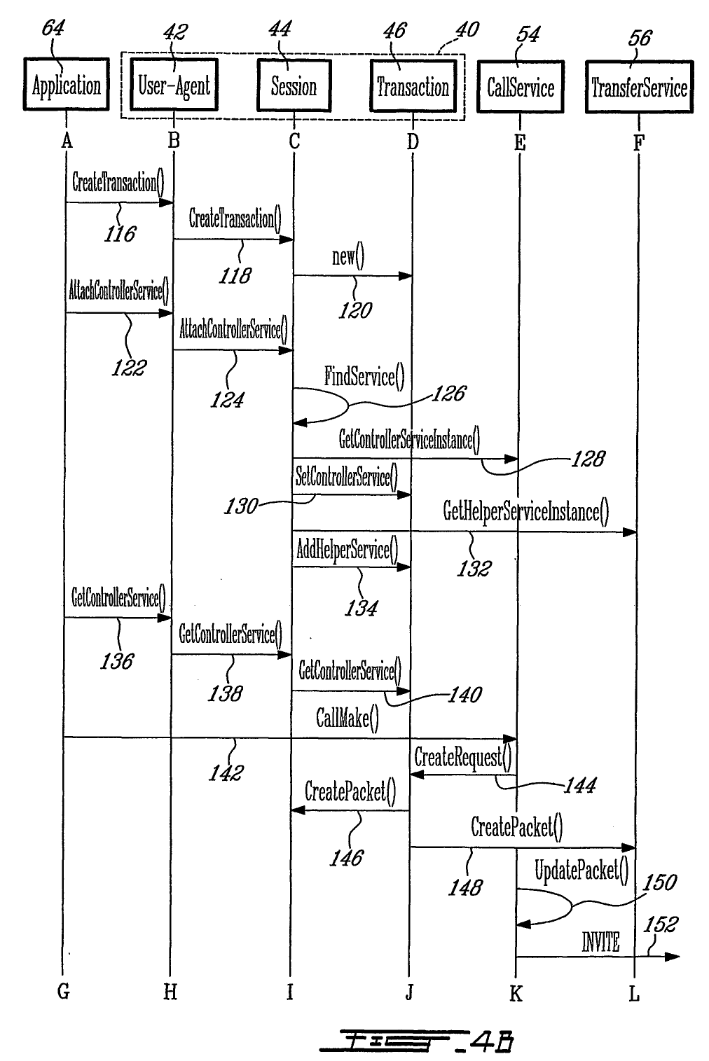

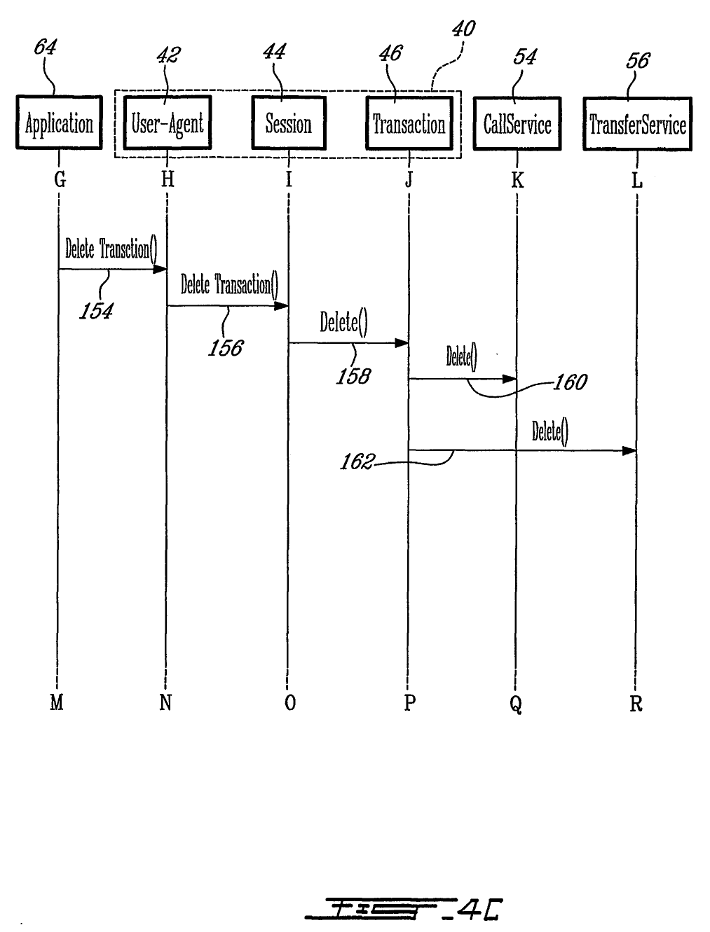

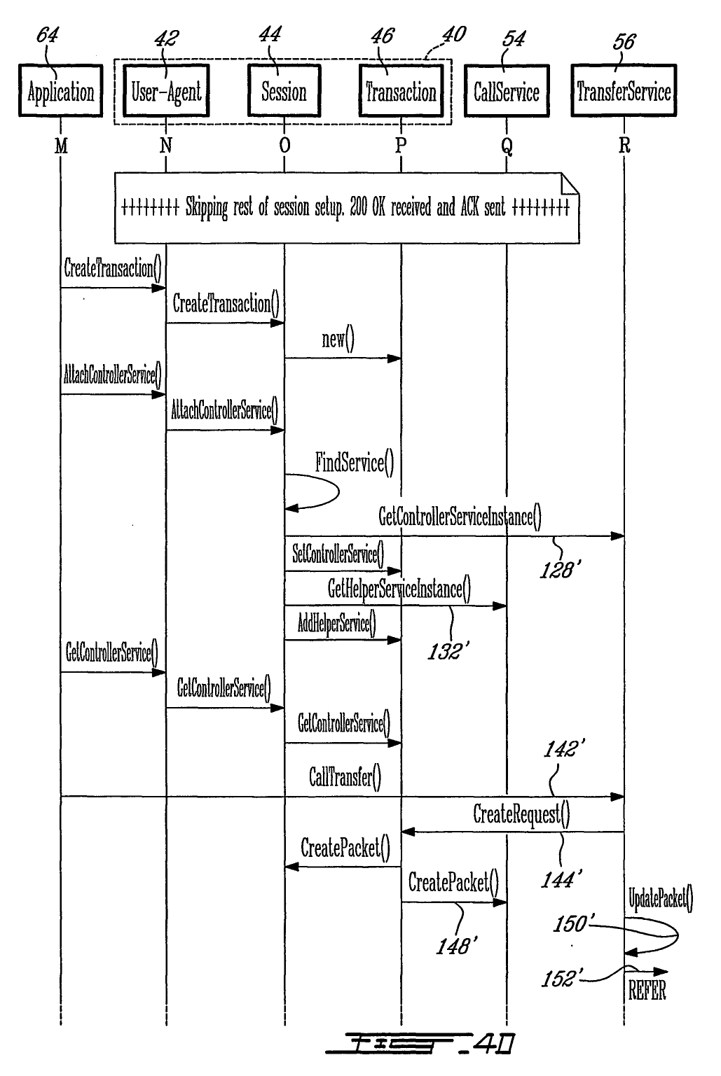

The stack 40 first includes an end-point controller class embodied in the example of FIG. 3 as a user agent class 42. The user agent class 42 is linked to the SIP application 64 (FIG. 4A) and is programmed for creating SIP sessions 44 and for conventionally holding and managing these sessions 44 for the SIP application 64.

The session class 44 is linked to the user-agent class 42 downstream from the application 64, as it is well known in the art. The session class 44 is programmed for creating transactions 46 so that the created transactions 46 are linked to the session 44 that they originate from, and for holding and managing these transaction 46.

As stated hereinabove, the session 44 and transaction 46 classes are service containers and as such, their instances are created empty of any service implementation instances. They are however programmed to receive service implementation instances from the application 64. Moreover, the User agent class 42 is a container of sessions and the session class 44 is a container of transactions.

According to the present invention, a service implementation is a class that is preferably responsible for an atomic feature of the base SIP or one of its extensions. This class derives from the “service” interface so as to be recognized by the container classes 42-46. Of course, a service implementation may alternatively be responsible for more than one feature.

The containers classes 42-46 are programmed to receive service implementations instances from the application 64 (exemplified by the API “+Add Service” 50 on FIG. 3) and retrieve them (exemplified by the API “+Get Service” 52 on FIG. 3) for the application 64. Classes that derive from the service class 48 do all the features implemented by the stack. When initializing a new session instance 44, the application 64 attaches the features it wants to the session instance 44 by calling the +Add Service API, making the attached features available to this new session instance 44. As can be seen in the UML diagram of FIG. 3, the container classes 4246 no longer hold the feature's states and intelligence, but they are located in the classes that derived from “service” 48.

To allow the application to use service implementations instances 54-58, it uses the “Get Service” API 52 to retrieve a pointer to the required feature instance and then use the API directly offered by the service implementation 54-58. Note that when the application retrieves a pointer to a service implementation through the “Get Service” API 52, the application retrieves a copy of a pointer to the service. Thus, the service remains attached to the container after a call to the “Get Service” API. API for removing a service from the container it is attached to are also advantageously included.

As can be seen on the UML diagram of FIG. 3, both the session and transaction classes can have and manage services.

The user agent class 42 is programmed to receive session service implementations 54-58 from the application 64 and to attach these session service implementations to a SIP session class instance 44.

In turn, the session class 44 is programmed for holding and managing the session service implementations 54-58 for the application 64. In addition, the session class 44 is programmed to retrieve transaction service implementations from the session services 54-58 and to attach these transaction service implementations to a transaction class instance 46.

Finally, the transaction class 46 is programmed for holding and managing transaction service implementations 54-56.

It is to be noted that the number of service implementations attached to the session and transaction instances 44 and 46 may vary. Moreover, since more than one session instances may co-exist at the same time, the user agent 42 is of course programmed so as to hold and manage more than one session 44. The session class 44 is similarly programmed for managing transactions 46.

Even though the user agent class 42 is not programmed to hold and manage service implementations, it is provided with service interfaces 50-52 allowing service interactions from the application 64 to the session and transaction classes 44 and 46.

The interfaces allow querying a session or a transaction for one of its service, and are thus provided with a parameter that specifies the session or transaction from which the service should be retrieved. Alternatively, an API may be provided at the User-Agent level that would simply return a pointer to a session (and have the session implement an API to return a pointer to a transaction), thus removing the need to have the User-Agent implementing the AddService and GetService interfaces.

It is to be noted that the names of the API 50 and 52 are only given for illustration purposes. As will be explained hereinbelow, the API allowing attaching and retrieving service implementations to and from the containers 42-46 can be different from one container to another.

As illustrated in FIG. 3, each service implementation 54-58 includes different features (for example, +MakeCall 60 and +Terminate Call 62 for the Call Service 54) that can be accessed using the corresponding service API.

Other features and characteristics of SIP stack architecture according to the present invention will become more apparent upon reading the following description of such stack in operation.

FIG. 4A, illustrates the creation of a SIP session instance 44 by the application and the addition of two service implementation instances 54-56 to the session instance 44.

In step 100, the application 64 sends an appropriate command to a User-Agent instance 42 for the creation of a new session instance 44. In step 102, the user agent instance 42 then creates a session instance 44 by dynamic memory allocation and keeps the pointer to the session received from the allocation, thus providing a link between the user agent instance 42 and session instance 44.

In step 104, the application 64 creates and links to a Call Service 54, which is concerned with making calls in Internet Telephony (IT). It is to be noted that, at this point, no service implementations have been added yet to any session and transaction instances 44-46.

Then, in step 106, the application 64 gives to the user agent instance 42 a session service implementation corresponding to the Call service instance 54 and, in step 108, attaches the session service implementation to the newly created session instance 44.

It is to be noted that the user agent class 42 is programmed to maintain information related to the different sessions it holds, since it can hold more than one session simultaneously.

Steps 104-108 are repeated for every service to be added to the session instance.

Indeed, steps 110-114 are respectively similar to steps 104-108, the difference being that they allow adding the Transfer service 56, which is concerned with call transfers in Internet Telephony (IT).

As illustrated in FIG. 4A, SIP stack architecture according to the present invention allows the application 64 choosing, at run-time, among a set of available services for a specific session. Thus, it allows the customization of features on a per-session basis.

The user agent 42, session 44 and transaction 46 classes, and of course the application 64, are advantageously programmed to create and discriminate between two types of services: those characterized as being session services, and those characterized as being transaction services.

A session service is an instance of a service implementation which is attached to a session instance. While attached to a session, the session service will keep service information for the duration of the session; it may also implement features at the session level that possibly do not interact with the transactions.

A transaction service is an instance of a service implementation which is attached to a transaction instance. Transaction services are created from a copy of the session services attached to the session owning the transaction. While attached to a transaction, the transaction service will keep service information specific for this transaction. Once the transaction is terminated, the transaction service may update its sibling session service with new state information. A transaction service can have one of two roles: It can act as a controller service or it can act as a helper service.

A controller service is the lead service of a transaction 46. It allows creating, SIP messages, sending and receiving SIP messages from the network for the transaction it is attached to, according to the feature the service implements.

A helper service helps the application by managing secondary information related to SIP messages sent and received by the controller service.

The concept of session, transaction, controller and helper services as well as the general operation of the SIP stack 40 will now be explained in more detail with reference to FIGS. 4B-4C, which illustrate a method of use of the two services introduced in FIG. 4A according to an embodiment of the present invention.

The method illustrated in FIGS. 4B-4D can be summarized as follows:

Creating a new transaction instance;

Among the services that were attached to the session instance, choosing one to be attached to the transaction that will act as the controller service for this new transaction. The controller service will be responsible for the final creation of the SIP packet and for sending it. Once a controller service is attached to a transaction, copies of the other session services will also be attached to the transaction but as helper services. The helper service will be able to modify the SIP packets before they are sent, and it will also be able to generate events to be reported to the application.

After attaching the controller service, the application querying the transaction for a pointer to its controller service. With this pointer, the application can now use any API calls offered by this service. The application could also use a helper service to further configure how the transaction will take place.

This method will now be explained in more detail with reference to FIGS. 4B-4D.

In step 116, the application 64 sends a command to the user agent 42 so as to create a transaction instance 46. The command includes information regarding the appropriate session instance 44 to which the transaction will be linked. In step 118, this information is used by the user agent 42 to command the selected session instance 44.

In step 120, upon receiving appropriate command from the application via the user agent instance 44, the selected session instance creates a transaction instance 46 so that the created transaction instance is linked to the selected session instance 44.

In step 122, the application 64 sends a command to the user agent 42 so as to attach a controller service implementation of the service 54 to the newly created transaction instance 46. In this example, the controller service is the Call service 54. Again, the command includes information regarding the appropriate session instance 44 to which the transaction instance 46 is linked.

In step 124, the user agent 42, in turn, commands the selected session instance 44 to attach the controller service implementation to the transaction instance 46. It is to be noted that a code identifying the controller service is passed from the application 64 to the session instance 44, via the user agent instance 42.

In step 126, upon receiving appropriate command from the application 64 via the user agent instance 42, the selected session instance 44 searches and finds among the list of session service implementations (in this example, only two) to find the session service implementation corresponding to the controller service 54.

In step 128, the session instance 44 retrieves a controller transaction service instance from the session service, and attaches it to the transaction instance 46 (step 130).

In step 132, the session instance 44 then retrieves helper transaction service instances from all remaining session services that had been previously attached to the session instances 44 (steps 106-114 on FIG. 4A) and attaches them to the transaction instance 46 (step 134) as helper services for this transaction.

At this point, the application 64 and the stack 40 are ready to create and manage packets via the attached service implementations.

In steps 136-140, the application 64 retrieves a pointer to the controller service 54 through the APIs offered by the container classes 42-46 so as to be able to directly use the API offered by the service 54 and more specifically one of its functions: “CallMake” (step 142). This function is responsible for initiating the proper signalling on the network to contact another SIP stack.

In step 144, the controller service implementation 54 asks the transaction instance 46 to create a SIP request packet. The transaction instance 46 and session instance 44 then create the request packet (steps 144 and 146). Then, in step 148, the transaction instance 46 asks all helper service implementations to contribute to the creation of the SIP packet. Only one iteration is needed on FIG. 4B since only one helper service is attached to the transaction. In step 150, the controller service is the last service to be able to modify the packet if needed, thus allowing the service to modify the packet over the modifications already provided by the helper service.

A series of iterations of steps 148 and 150 may occur in order to finalize the packet before sending it through the Internet in step 152. The number of such iterations may vary depending on the number and nature of the controller and helper service implementations attached.

Of course, depending on the action or reaction on the packet, the application, via the stack 40, may perform different operation, such as acknowledging the final response to an INVITE command (step 152 on FIG. 4C). Since, such operations are commonly known in the art, and for concision purposes, they will not be described herein in more detail.

FIG. 4C illustrates an operation that is performed whenever a transaction is to be deleted, for example after a transaction completes or times-out.

Upon receiving an appropriate command from the application 64 via the user agent instance 42 (steps 154-156), the session instance 44 deallocates the transaction (step 158) which in turn has the effect of making the transaction deallocates the services that had been previously attached to it (steps 160 and 162).

FIG. 4D illustrates the use of a second service: the Call transfer service 56.

Since, the operation of the application 64 with the stack 40 is very similar to the one described with reference to FIG. 4B, and for concision purposes, only the major differences will be described herein in more detail.

In step 128′, since it is the Transfer service 56 that is retrieved as the controller service, in step 132′, the Call service 54 is retrieved and attached as a helper service.

In step 142′, the function that is to be used by the application 64 is “CallTransfer” from the Transfer service 56.

Since the Transfer service 56 acts as the controller service, the creation of the packet is initiated by the Transfer service 56 and then proceeds with the helper service 54 (step 144′-150′).

In step 152′, the packet related to the transfer of a call is sent via the network (not shown).

Finally, upon receiving appropriate command from the application 64 via the user agent instance, the session instance deletes the transaction class.

It is to be noted that, even though the examples illustrated in FIGS. 4A-4D, depict only two services, conventional SIP Internet telephony applications use many more services.

Examples of other services may include:

Basic Service: Implements the necessary functionality to send and receive basic SIP requests and responses (Non-INVITE and non-ACK);

Call Service: Implements the necessary functionality to establish (make or receive) a call with the help of the INVITE and ACK requests;

Transfer02—Implements the call-transfer service as defined in the second IETF draft for this service;

Transfer05—Implements the call-transfer service as defined in the fifth IETF draft for this service;

SessionTimers04: Implements the session-timer feature (or draft or service or functionality) as defined in the fourth IETF draft for this service;

SessionTimers08: Implements the session-timer feature (or draft or service or functionality) as defined in the eighth IETF draft for this service;

Record-Route service: Manages the “Route” and “Record-Route” requirements of the SIP specification;

Authentication Service: Provides the necessary functions to authenticate any SIP request; and

Registration Service: Provides an easy way for the application to manage registrations to a SIP server.

Of course, the previous list is firstly non-exhaustive. Secondly, it is believed to be within the reach of a person skilled in the art to implement different services according to the present invention.

A SIP application using a service-based architecture according to the present invention can choose to modify or replace a service already provided with the stack. The modification of an already existing service can be done according to either one of the following two methods:

Rewriting a completely new service from scratch with the desired behaviour, and using it instead of the service it modifies;

Through C++ derivation process, creating a new C++ class that inherits from the “service to modify”, and rewriting the parts of the services that needs modification. Using this new class instead of the “service to modify” when adding the services to use in the stack.

Since session and transaction classes according to the present invention are containers of services, the application has the choice to add any service from those available when these containers are created. Thus, the application has the options to include all the services that were provided with the stack, to include just a few services provided with the stack and include some services of its own, or to use services of its own and no services provided with the stack. The application simply inserts the service it has created/modified instead of another service.

Although the present invention has been described by way of reference to a SIP User-Agent, it can be used also for other SIP end-point controllers (or SIP entities) such as a SIP proxy server and a back-to-back user agent.

The C++ language has been found advantageous to program the container classes and application according to the present invention. Of course, the present invention does not require the use of C++ for its implementation.

Although the present invention has been described hereinabove by way of preferred embodiments thereof, it can be modified without departing from the spirit and nature of the subject invention, as defined in the appended claims.

What is claimed is:

1. A Session Initiation Protocol (SIP) stack for a SIP application programmed to use at least one service, the stack comprising:
an end-point controller linked to the SIP application for creating at least one SIP session so that each said at least one session is linked to said end-point controller, and for holding and managing said at least one SIP session for the SIP application; said end-point controller being programmed to receive at least one session service implementation from said application and to attach said at least one session service implementation to one of said at least one SIP session;
said at least one session being programmed for creating at least one transaction so as to be linked thereto, and for holding and managing said at least one transaction and said at least one session service implementation for the application; said at least one session being programmed to retrieve at least one transaction service implementation from said at least one session services and to attach said at least one transaction service implementation to said at least one transaction; and
said at least one transaction being programmed for holding and managing said at least one transaction service.

2. A SIP stack as recited in claim 1, wherein said end-point controller is selected from the group consisting of a user agent, a SIP proxy server, a SIP registrar server, a SIP redirect server, and a back-to-back user agent.

3. A SIP stack as recited in claim 1, wherein said end-point controller, said at least one session, and said at least one transaction are programmed with respective interfaces allowing service interactions between the application, said end-point controller, said at least one session, and said at least one transaction.

4. A SIP stack as recited in claim 3, wherein said respective interfaces are Application Programming Interfaces (API).

5. A SIP stack as recited in claim 1, wherein the stack is programmed in a programming language that permits polymorphism.

6. A SIP stack as recited in claim 5, wherein said polymorph programming language is selected from the group consisting of C++, C# and Java.

7. A SIP stack as recited in claim 1, wherein said at least one service is created by rewriting at least part of an existing service, and creating a class that inherits from said at least part of an existing service rewritten.

8. A method of use of at least one service in a Session Initiation Protocol (SIP) application, the method comprising:
i) upon receiving appropriate command from the application, an end-point controller creating at least one session so that each said at least one session is linked to said end-point controller;
ii) for each current service from the at least one service:
a) the application linking to said current service; and
b) upon receiving appropriate command from the application, said end-point controller receiving a session service implementation corresponding to said current service from said application and attaching said session service implementation to a selected one of said at least one session;
iii) upon receiving appropriate command from the application via said end-point controller, said selected one of said at least one session creating a transaction so that said transaction is linked to said selected one of said at least one session;
iv) upon receiving appropriate command from the application via said end-point controller, said selected one of said at least one session retrieving at least one transaction service implementation from said at least one session service and attaching each said at least one transaction service implementation to said transaction; and
v) upon receiving appropriate command from the application, one of said at least one said transaction service implementation using said transaction so as to create and/or modify a packet.

9. A method as recited in claim 8, further comprising:
vi) upon receiving appropriate command from said one of said at least one transaction service implementation, said transaction using said session and other one from said at least one transaction service implementations so as to modify said packet.

10. A method as recited in claim 9, wherein step vi) is repeated for all other one of said at least one transaction service implementation.

11. A method as recited in claim 10, wherein step vi) is repeated more than once.

12. A SIP stack as recited in claim 9, wherein said selected one of said at least one session receiving at least two transaction service implementations from said application; one of said at least two transaction service implementations acting as a controller service implementation; the other one from said at least one transaction service implementation acting as a helper service implementation.

13. A method as recited in claim 8, wherein said end-point controller is selected from the group consisting of a user agent, a SIP proxy server, a SIP registrar server, a SIP redirect server and a back-to-back user agent.

14. A method as recited in claim 8, wherein said end-point controller, said at least one session, and said at least one transaction are programmed with respective interfaces allowing service interactions between the application, said end-point controller, said at least one session and said at least one transaction.

15. A method as recited in claim 14, wherein said respective interfaces are Application Programming Interfaces (API).

16. A method as recited in claim 8, wherein said selected one of said at least one session is created by dynamic memory allocation;
said end-point controller keeping a pointer to said selected one of said at least one session received from the dynamic memory allocation, thereby providing a link between said end-point controller and said selected one of said at least one session.

17. A method as recited in claim 8, wherein said at least one transaction is created by dynamic memory allocation; said at least one session keeping a pointer to said at least one transaction received from the dynamic memory allocation, thereby providing a link between said at least one session and said transaction.

18. A method as recited in claim 8, wherein a code identifying said at least one transaction service implementation is passed from the application to said selected one of said at least one session via said end-point controller when said selected one of said at least one session receiving at least one transaction service implementation from said application.

19. A method for adding a service from a Session Initiation Protocol (SIP) application to a SIP stack comprising an end-point controller linked to the application, at least one session linked to the end-point controller, and at least one transaction linked to a selected one of the at least one session, the method comprising:
the application linking to the service;
upon receiving appropriate command from the application, said end-point controller receiving a session service implementation corresponding to said service from said application and attaching said session service implementation to the selected one of said at least one session; and
upon receiving appropriate command from the application via said end-point controller, said selected one of said at least one session retrieving a transaction service implementation from said session service implementation and attaching said transaction service implementation to said transaction.

20. A method as recited in claim 19, wherein said end-point controller is selected from the group consisting of a user agent, a SIP proxy server, a SIP registrar server, a SIP redirect server and a back-to-back user agent.

21. A method as recited in claim 19, wherein said session service implementation is automatically added to said at least one session by said end-point controller.

22. A method as recited in claim 19, wherein said application is configured to remove session service implementation previously attached to said at least one session via said end-point controller.

23. A method as recited in claim 19, wherein said transaction service implementation is attached to said at least one transaction by said application via said end-point controller.

24. A method as recited in claim 19, wherein said application is directly linking to said at least one session without linking to said end-point controller.
